(19) United States
(12) Patent Application Publication
(10) Pub. No.: US 2013/0115157 A1
(43) Pub. Date: May 9, 2013

(54) CALCINING CHAMBER AND PROCESS

(71) Applicant: Matthew Sakae Forkin, San Mateo, CA (US)

(72) Inventor: Matthew Sakae Forkin, San Mateo, CA (US)

(73) Assignee: MEYER INTELLECTUAL PROPERTIES LTD., Kowloon, Hong Kong (CN)

(21) Appl. No.: 13/810,193

(22) PCT Filed: Jul. 12, 2011
(86) PCT No.: PCT/US11/43723

§ 371 Date: Jan. 14, 2013

Related U.S. Application Data
(60) Provisional application No. 61/367,320, filed on Jul. 23, 2010.

(51) Int. Cl. C01B 33/10

(52) U.S. Cl. CPC C01B 33/10
USPC 423/341; 422/224

(57) ABSTRACT

Solid materials capable of producing toxic and/or corrosive gases by thermal decomposition are heated in a stirred in a sealable crucible. The stirring rod is supported on a downward extending shaft using a combination of a lip seal or other mechanical seal and a ferro-fluidic seal or rotary feed through. The lip seal region is evacuated to reduce the chance that the small upward flow of corrosive gas will detrimentally react with components of the ferro-fluid. In a process for calcining sodium fluorosilicate to product silicon tetra-fluoride gas, the lip seal and ferro-fluidic seal regions are purged and/or blanked to prevent the absorption of water during an initial drying phase. A preferred embodiment of the process of synthesis of a high purity corrosive gas generated by decomposition of a precursor solid at high temperature deploys a dry vacuum pump and a compressor in series so that the corrosive gas is pressurized as it fills storage containers. Accordingly, the reaction of water with silicon tetra-fluoride to produce corrosive hydrogen fluoride gas is prevented.

### CROSS REFERENCE TO RELATED APPLICATIONS

The present application claims the benefit of priority to the International (PCT) Patent application PCT/US11/45351 filed on 26 Jul. 2011 for a “Calcining Chamber and Process”, which is incorporated herein by reference which in turn claims the benefit of priority from the US Non-Provisional Patent Application for the “Contamination Free Compression of a Corrosive Gas” that was filed on Jul. 21, 2011, having application Ser. No. 13/188,353, and is incorporated herein by reference, and also claims the benefit of priority from the US Provisional Patent Application for the “Contamination Free Compression of a Corrosive Gas” that was filed on Jul. 26, 2010, having application Ser. No. 61/367,627, and is also incorporated herein by reference.

The present application also claims the benefit of priority to the International (PCT) application PCT/US11/43723 filed on 12 Jul. 2011 for a “Calcining Chamber and Process”, which is incorporated herein by reference, which in turn claims the benefit of priority form the US Provisional Patent Application for the “Calcining Chamber and Process” that was filed on Jul. 23, 2010, having application Ser. No. 61/367,320, which is also incorporated herein by reference.

### FIELD OF INVENTION

The present field of invention is apparatus and method related to the production, compression, and storage of corrosive gases, and in particular to the production of silicon tetrafluoride (SiF₄) by calcining sodium fluorosilicate (SFS).

### BACKGROUND OF INVENTION

Numerous chemical processes to produce high purity materials, and in particular contaminant free electronic grade materials such as semiconductors, utilize highly reactive gas. One method of producing such high purity gases is by the calcining of a solid precursor in which the contaminants are rejected by either remaining as solids in the precursor or by phase segregation in the synthesis of the precursor.

Gases used to synthesize such materials are generally highly reactive, and hence can attack or corrode congenital hardware and equipment used in there production unless special precautions are taken in sealing the materials of contraction of the equipment used to contain the synthetic process.

A particularly challenging problem can involve rotary seals, in particular stirring shafts. This is particularly an issue in a calcining process in which heat transfer from the walls of the vessel to the interior of the solid would be slow without stirring, which also enable the rapid release of the gas produced by the thermal decomposition process.

One non limiting example of such a process is thermal decomposition of sodium fluorosilicate (SFS) to produce silicon tetrafluoride (SiF₄) which among other uses is, can be reacted with liquid sodium metal to produce Silicon metal. As sodium must be highly pure for use as a semiconductor in electronic and photovoltaic applications, it is of paramount importance that the SiF₄ is not only pure, but does not become contaminated by reaction with the process equipment. SIF₄ itself is toxic and highly corrosive. Further, it readily reacts with water to process hydrofluoric acid, which is more corrosive.

Calcining SFS is particularly problematic because it must first be dried at under about 400° C. to remove up to about 0.5% absorbed water. The water must also be removed from, but preferably prevented from entering any part of the apparatus that then is potentially exposed to even small quantities of SIF4 gas to prevent the formation of hydrofluoric acid (HF).

Accordingly, it is an object of the invention to provide a method and apparatus for calcining solid materials at high temperatures with stirring that neither contaminates the gas produced nor allows it to leak from the chamber.

### SUMMARY OF INVENTION

In the present invention, the first object is achieved by providing an apparatus comprising a sealable chamber, rotatable shaft descending downward from the upper portion of said chamber, a stirring blade disposed at the end of said shaft distal from the upper portion of said chamber that substantially conforms to the curvature of at least the bottom of said chamber, an upper ferro-fluidic seal connecting the upper end of said rotatable shaft to a drive shaft external to said chamber, a lower dual lip seal disposed between the upper fluidic seal and the interior of said chamber that surrounds said rotatable shaft, a first portal in fluid communication with a first region surrounding said rotatable shaft disposed between the upper ferro-fluidic seal and lower lip seal for the selective evacuation and blanketing of said first region, a second portal in fluid communication with a second region surrounding said rotatable shaft disposed between dual lip seals for the selective evacuation and blanketing of said second region.

A second aspect of the invention is characterized by a process for synthesizing silicon tetra fluoride comprising the steps of providing a heatable chamber having a sealable stirring rod, charging the chamber with solid sodium fluorosilicate (SFS), stirring the solid sodium fluorosilicate, heating the SFS to at least 400° C., removing water from the chamber, heating the SFS to at least 700° C., removing the SiF₄ from the chamber, wherein the sealable stirring rod is isolated from the outside of the chamber by a ferro-fluidic seal and the interior of the chamber is isolated from the ferro-fluidic seal by a lip seal.

The above and other objects, effects, features, and advantages of the present invention will become more apparent from the following description of the embodiments thereof taken in conjunction with the accompanying drawings.

### BRIEF DESCRIPTION OF DRAWINGS

FIG. 1 is a cross sectional elevation of the calcining apparatus and chamber.

FIG. 2 is a cross sectional elevation of the stirring rod seal region of the calcining chamber of FIG. 1

FIG. 3 is a top plan view of the calcining chamber of FIGS. 1 and 2.

FIG. 4 is a schematic diagram of another aspect of the invention.

FIG. 5 is a schematic diagram of an alternative embodiment of the invention to that illustrated in FIG. 4

FIG. 6 is a schematic diagram of another alternative embodiment of the invention to that illustrated in FIGS. 4 and 5.

### DETAILED DESCRIPTION

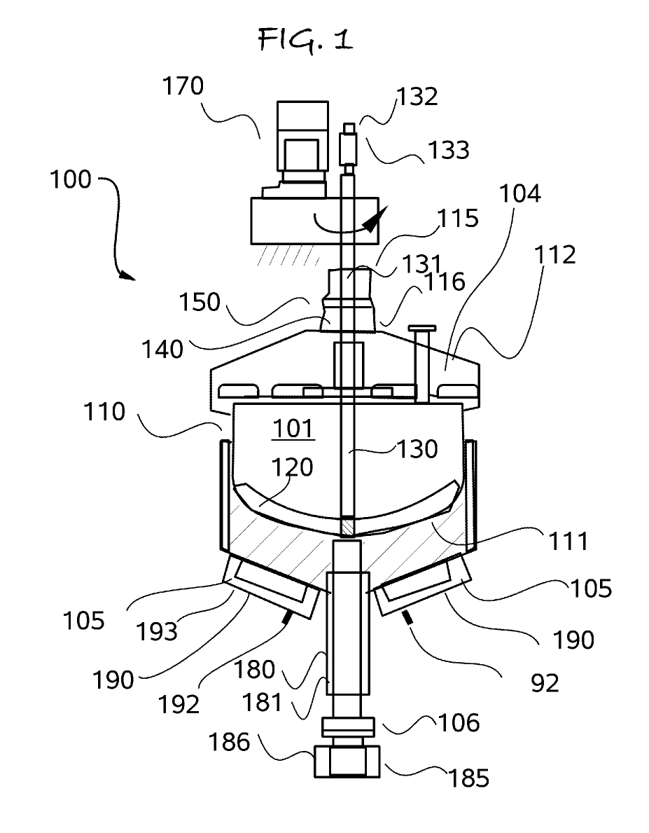

Referring to FIGS. 1 through 6 wherein like reference numerals refer to like components in the various views, there is illustrated therein a new and improved calcining chamber and process, generally denominated 100 herein.

In accordance with the present invention, calcining apparatus 100 includes a heatable calcining chamber 110 having an internal region 101 that is capable of having the contents therein mixed with rotatable stirring blade 120 situated in close proximity to the bottom 111 of heatable calcining chamber 110. The rotatable stirring blade 120 is disposed at the distal end of the stirring shaft 130 that descend down from the top 112 of the heatable calcining chamber 110, entering at portal 115. Between portal 115 and the opening into the wider heatable calcining chamber 110 is a generally cylindrical channel housing 116. Within cylindrical channel housing 116 a lower shaft lip seal 140 that surrounds the shaft 130. Above this lower lip seal 140 is a ferro-fluidic seal 150, so that the shaft can extend though portal 115 for rotation by motor 170.

Thus, there is an annular cavity 143 around both the lip seal 140 and another annular cavity 153 around the ferro-fluidic seal 150, each having the inner surface of the generally cylindrical housing 116. The drive shaft of the ferro-fluidic seal is connected to a motor 170 that the drives the shaft and stirrer. The annulus 143 about lip seal 140 is preferably flushed with an inert gas or evacuated via the external portal 245 formed in the housing. Likewise the annulus 153 about ferro-fluidic seal 150 is preferably flushed with an inert gas or evacuated via the external portal 246 formed in the housing.

More preferably, the lip seal 140 has two round sealing gaskets (141a and 141b) disposed one above the other to form an inner annular region 243, which optionally has it's own portal 245 for evacuation or flushing with an inert gas. The round sealing gaskets 141a and 141b are preferably made of an inert fluorocarbon resin filled with carbon or graphite fiber to add strength and stiffness. Other mechanical seal devices such as face seals could also be used in place of the lip seals for various applications.

The cylindrical housing 116 is preferably surrounded by a sealable annulus through which cooling water flows when the chamber 110 is heated to prevent over heating of the valves and seal means. This, and other cooling means discussed below, allow the operation of the chamber at high temperatures without damaging the mechanical and moving components on the exterior and their related feedthroughs.

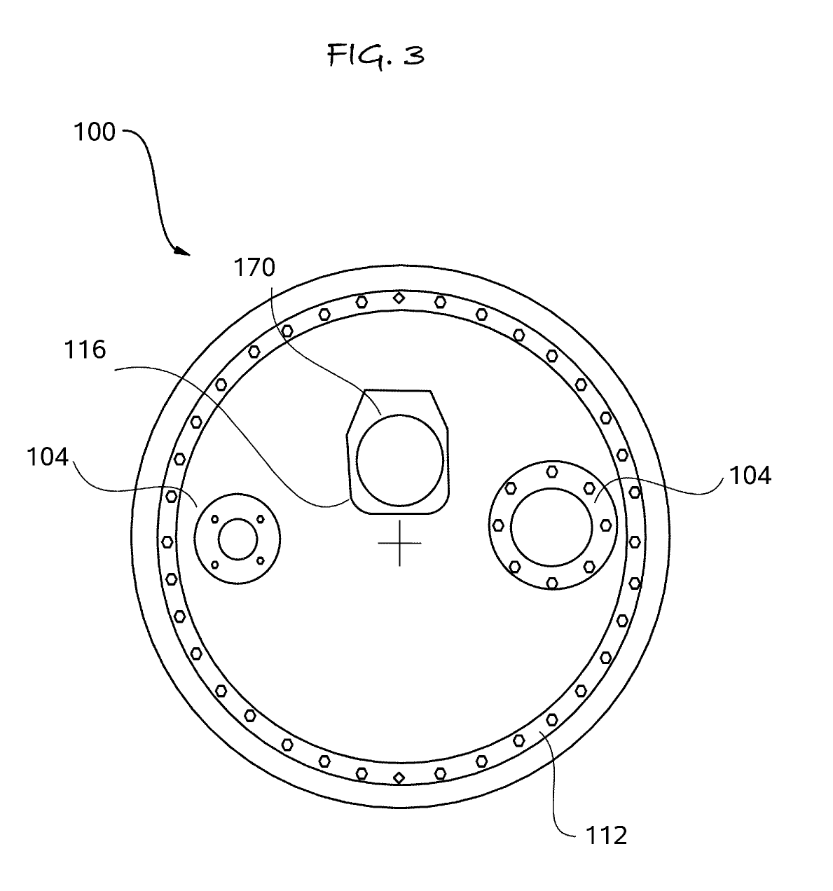

FIG. 3 illustrates the position on numerous entry ports 104 on the upper half or top 112 of the chamber 110. Support of the motor 170 and the rotary coupled shaft 130 is preferably totally external, with no internal contact of the stirring blade and shaft in the interior of chamber 110 to prevent contamination. Further, the stirring blade 120 and shaft 130 are preferably Inconel 625 metal plated or clad with pure nickel 200. Chamber 110 is preferably itself explosion clad nickel 200 on Inconel 625 alloy. These materials are specifically chosen for their high-temperature compatibility with SiF₄ gas, however other materials could also be chosen in other applications.

In a preferred embodiment of the invention, the stirring blade 120 is preferably helically spiraled with a tilted leading edge. Anther important aspect of the invention is the provision of a cooling channel 131, in stirring shaft 130, which receives cooling fluid at inlet 132, which is then drained from channel 131.

Most, preferably chamber 110 includes a sealable cylindrical extension or discharge chamber 180 that extends downward from the center thereof, which terminates discharge port 106 having a gas and vacuum tight valve 185. The discharge chamber may terminate with multiple gas tight valves to provide a load lock chamber for removing the residual solids from the calcining phase without admitting outside air into chamber 110.

In addition, it is also preferred to deploy heaters 105 surrounding the discharge chamber 180. The heaters 105 are preferably infrared heaters that do not touch the outside of the chamber 110. A cooling jacket 190 surrounds the infrared heaters, which receives cooling fluid at inlet 192, which is then drained from jacket 190 at outlet 193. Another cooling jacket is the annulus 181 that surrounds the discharge chamber 180. There is also an annular cooling jacket 186 disposed about discharge valve 185.

Another aspect of the invention is a process for the synthesis of SiF₄ from SFS using the above apparatus. In the first phase the chamber 110 is charged with SFS and sealed prior to heating the contents to at least above about 100° C., but more preferably up to about 400° C. to remove the absorbed water. Prior to initiating this dehydration phase the annular region 153 surrounding the ferro-fluidic seal 150 is flushed with a dry inert carrier gas, preferably dry Argon gas, to preventing moisture ingress. The lower annular region 243 is evacuated to remove the water vapor produced by dehydration of SFS or alternatively also flushed with dry inert gas at a pressure below that of region 153, but above that of the chamber 101. The interior 101 of chamber 110 is preferably also flushed with a dry inert gas (Argon) during the dehydration process, or alternatively can be evacuated during dehydration of SFS. Thus, the inert gas in the region of lip seal 140 will be at positive press with respect this region preventing moisture ingress. The dehydration preferably occurs with continues rotation of the shaft 130 and stirring bar 120 to accelerate the heating of the SFS charge to uniform temperature and insure complete dehydration. Chamber interior 101 is flushed with dry argon during dehydration, while a vacuum pump removes the carrier gas and moisture.

In the subsequent process step of heating the SFS to the decomposition temperature of at least 500° C., but more preferably circa 700 to 800° C., the primary route for evacuation of SiF₄ is a chamber portal 104. However, both the lower 243 and upper annular region 153 are also differentially pumped to remove any SiF₄ that leaks through the lip seals. The chamber 110, as shown in FIG. 3, may have multiple top portal 104 for charging reactant SFS, and pumping off moisture during dehydration, as well as removing SiF₄ during calcining.

Alternatively, during the above calcining process, the upper annular region 153 can be flushed with an inert gas and the lower annular region 243 can be evacuated so that any SiF₄ that leaks past the lip seal is rapidly diluted by this carrier gas and removed before it can interact with the ferro-fluid materials. The evacuation also prevents any inert carrier gas from leaking past the lower lip seal into the chamber interior 101 where it would dilute the product SiF₄ being generated therein. Thus, after dehydration of the SFS charge is complete, the source of the inert flushing gas is closed and the pump or line removing this inert gas and moisture is shut off or closed. Then the heaters 105 are energized while blade 120 is rotated by attached rod 130 so that the dry SFS charge is mixed as it reaches the decomposition temperature. The product SiF₄ is removed by a separate vacuum pumping system that provides an internal pressure in chamber 110 of preferably between about 20-50 torr.

In the preferred mode of dehydration of SFS, the upper chamber is flushed with dry argon, but pumped at a sufficient speed to provide a local pressure of about 850 torr, the lower region is also flushed with dry argon to provide a local pressure of above 800 torr, and the chamber interior 101 is also flushed with dry argon to provide a pressure of about 750 torr. The flushing with dry argon in this stage also prevents any accumulate of fine particulate at the lip seal 140.

On calcining however, the upper annular chamber 153 and lower annular chamber 243 could be sealed off or evacuated. If they are evacuated it is preferred that the lower annular chamber 243 be pumped at a speed so the local pressure is about 5 torr, while the upper annular chamber 153 reaches a higher local pressure of about 20 torr, and the interior 101 of the chamber 110 having a local pressure of about 20 to 200 torr, but more preferably 20 to 50 torr. Under the latter conditions of lower pressure in the chamber 110 it was discovered that the clumping of SFS powder during calcining was generally minimized if not avoided, provided the mixing from stirring blade 120 was at a high enough speed. It was further discovered that avoiding such clumping apparently provided more efficient mixing during calcining as it lead to a notable increases throughput and completeness of the decomposition reaction, improving the process yield.

It should be noted that absent the stirring of reactant SFS, the charge in the chamber 110 would turn to solid block on heating, and the remaining sodium fluoride sinter together

Accordingly, it should now be appreciated that the use or deployment of the above non-leaking calcining chamber with stirring results in several mutual benefits, which include a high throughput and efficiency of a decomposition reaction, as well as the avoidance of contamination from the stirring blade along with greater safety from the high reliability of rotation shaft seal mechanism.

Another particularly challenging problem in producing SiF4 and other corrosive gases is an efficient means to remove them from a reaction chamber and compress them for storage. Conventional vacuum pumps can be used, but must deploy a cryo-trap to condense the gas in front of the vacuum pump to prevent contamination of the product gas, as well as damage to the pump. This then requires a second process to warm up the condensed solid, to form a gas that can be compressed for storage in inert high pressure contains. The process is time consuming and inefficient and not well suited for continuous product processes.

One non limiting example of such a process is thermal decomposition of sodium fluorosilicate (SFS) to produce silicon tetrafluoride (SiF4) which among other uses is, can be reacted with liquid sodium metal to produce silicon metal. As silicon must be highly pure for use as a semiconductor in electronic and photovoltaic applications, it is of paramount importance that the SiF4 is not only pure, but does not become contaminated by reaction with the process equipment. SiF4 itself is toxic and highly corrosive. Further, it readily reacts with water to process hydrofluoric acid, which is more corrosive. At has recently been discovered that this process is most efficient and has a higher yield when the SFS powder is agitated and stirrer at pressure of about 50 to 200 torr. Hence, there is a need to collect the SIF4 gas at such pressures.

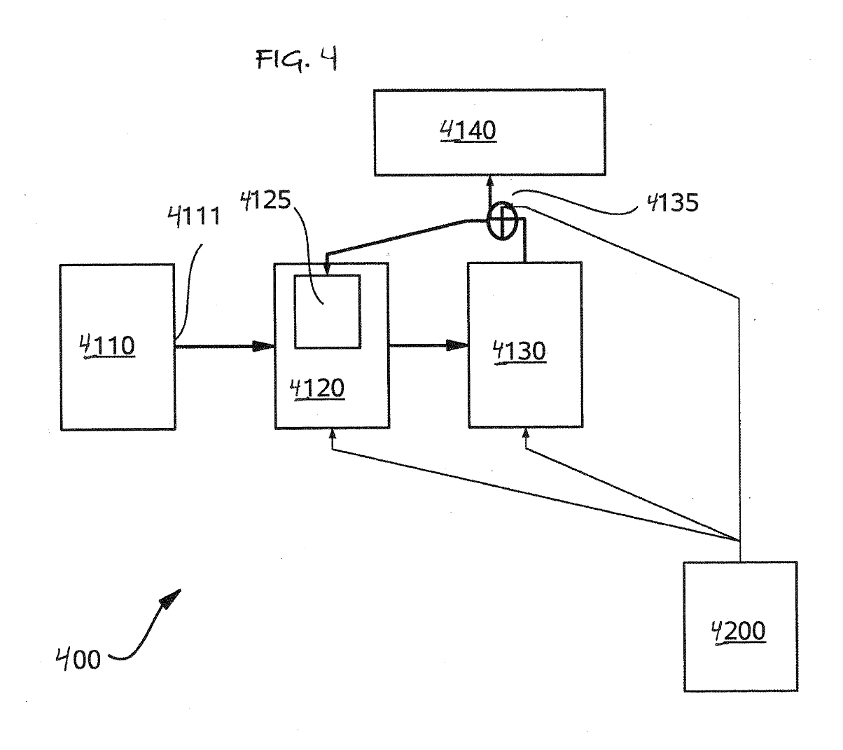

As illustrated in FIG. 4-6, another embodiment of the invention is the pumping apparatus 400 which is deployed to collect and compress SiF4 gas that is formed by the thermal decomposition of dry SFS at or above 700° C. It has been discovered that optimum pressure for such decomposition is generally from about 20 to 200 torr.

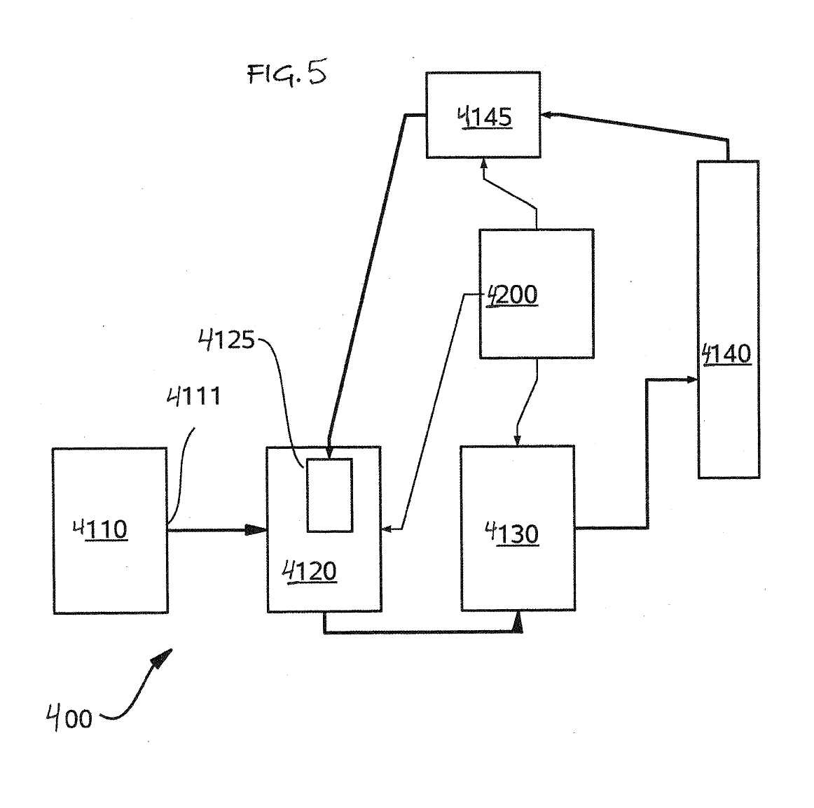

A decomposable solid, such as SFS, is introduced into a heatable chamber 110. The chamber 110 is evacuated, and then heated to the heat the solid to the decomposition temperature so that a pure gas is released. The gas is removed at an exhaust portal 111 by the action of a first dry vacuum pump 4120 in communication therewith. This first vacuum pump 4120 delivers the exhausted gas to a compressor 4130, with compresses the gas into one or more storage tanks 4140. To prevent contamination of the gas from seal region 4125 of the vacuum pump 4120, a small portion of the compressed gas is continuously bled off of the compressor 4130 (as shown in FIG. 4) from the feed line to the tanks 4140, and fed back to flush the seal regions 4125 of the first vacuum pump 4120. Alternatively, as shown in FIG. 5, the compressed gas in the storage tank 4140 can be fed back to flush the seal region 4145 of the first vacuum pump 4120.

U.S. Pat. No. 4,734,018, which is incorporated herein by reference, discloses one such dry vacuum pump that is generally suitable for use in the inventive apparatus and method. The pump deploys multiple a labyrinth seals between the bearings that support a rotary member that turns the pumps compressor shaft. The labyrinth seals thereof may be flushed with the bled of gas from the compressor as described above.

U.S. Pat. No. 6,189,176, which is incorporated herein by reference, discloses a high pressure glass cleaning purge of silicon oxide dust from a dry vacuum pump while installed on a crystal grower.

The dry vacuum pump and the compressor must not have any leaks that allow gas to leak in from the environments, as well as prevent the leakage of the pure gas formed from thermal decomposition out.

The portions of each pump apparatus that are exposed to the pure gas are constructed of materials that are substantially non-reactive therewith, thus avoiding contamination of the by-producers of such a reaction. Such materials include pure nickel for forming, cladding or coating metal components, and flouropolymers for resilient and flexible components.

In the start up phase when the compressor has not yet produced a sufficient quantity of pure gas to flush or purge the seal regions of the first vacuum pump, such pure gas can be provided from a storage tank.

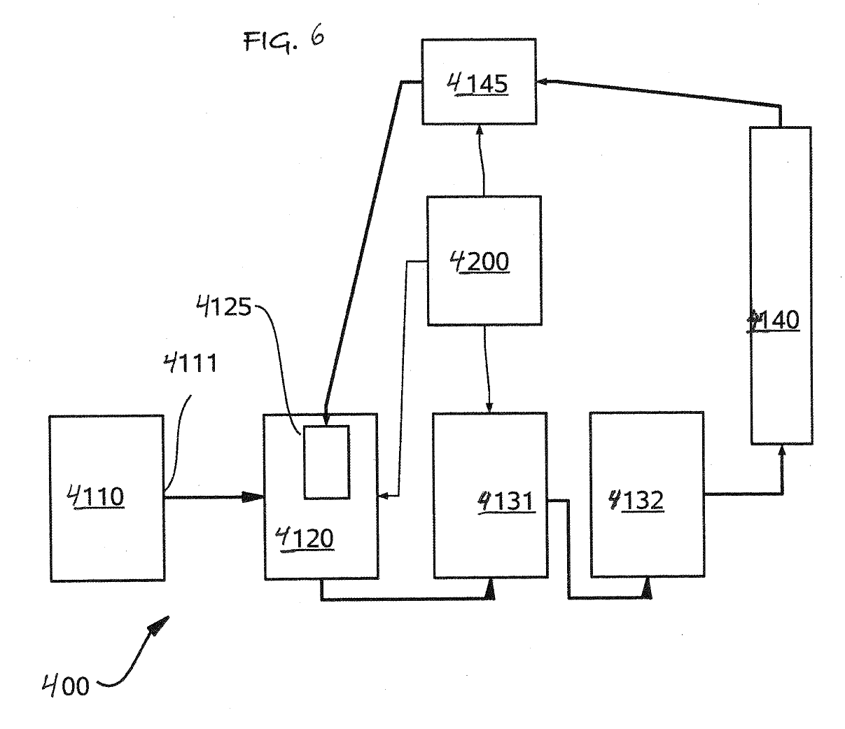

While the dry vacuum pump can evacuate to low pressure, the gas thus removed can only be compressed at the output port to few psi. Hence there was also a need for then deploying a compressor that receive the output of the dry vacuum pump at about 2 psig, and compressing it in a first stage to 60 psig, and in the second stage from about 60 psig to preferably at least about 300 psig for storage in tanks. Further, it is also desirable that at least one particulate filter is deployed between the first dry vacuum pump and the compressor. FIG. 6 illustrates such an to apparatus 400 having a first compressor 4131 connected to receive the output of the dry vacuum pump and a second compressor 4132 connected thereto for another stage of compression beyond about 60 psig to preferably about 300 psig.

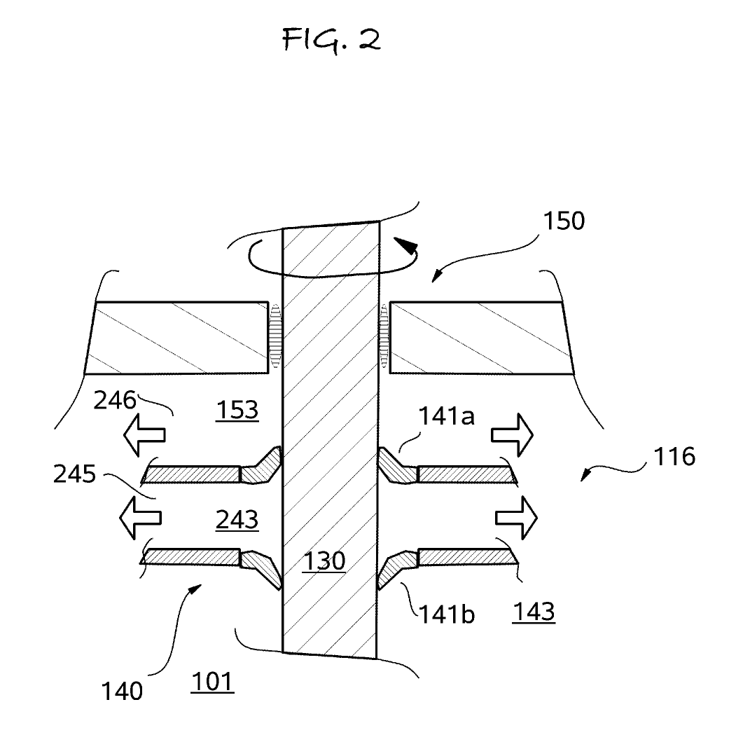

It is also preferred to deploy a control system that simultaneously maintains each pump at a speed to provide the optimum pressure for the other pump. In start up, the compressor starts first, then the dry vacuum pump after the optimum operating pressure is reached, and the vacuum pump seal region is fed with the compressed SiF4 gas. As shown in FIG. 4, control system 4200 is also operative to modulate a valve 4135 that controls the bleed of compressed gas from compressor 130 to the seal region 125 of pump 120. In contrast, in FIG. 2, controller 4200 is operative to modulate a valve 4145 that controls the flow of gas from tank 4140 to the seal region 4125 of pump 4120.

The gas mixture that flushes the seal region is preferably either trapped with a cryo-pump or captured by reaction with a solid leaving a safely disposable residue or a material that can be returned to chamber for re-processing.

While the invention has been described in connection with a preferred embodiment, it is not intended to limit the scope of the invention to the particular form set forth, but on the contrary, it is intended to cover such alternatives, modifications, and equivalents as may be within the spirit and scope of the invention as defined by the appended claims.

1. A process for synthesizing silicon tetra fluoride comprising the steps of:
a) providing a heatable chamber having a sealable stirring rod,
b) charging the chamber with solid sodium fluorosilicate,
c) stirring the solid sodium fluorosilicate,
d) heating the SFS to at least above about 100° C.,
e) removing water from the chamber,
f) heating the SFS to at least about 500° C.,
g) removing the SF4 from the chamber,
h) wherein the sealable stirring rod is isolated from the outside of the chamber by a ferro-fluidic seal and the interior of the chamber is isolated from the ferro-fluidic seal by a lip seal.

2. A process for synthesizing silicon tetra-fluoride according to claim 2 that further comprises the step of blanketing the ferro-fluidic seal with a dry inert gas during said step of removing water from the chamber.

3. A process for synthesizing silicon tetra-fluoride according to claim 2 that further comprises the step of evacuating the ferro-fluidic seal region during said step of removing the SiF₄ from the chamber.

4. An apparatus comprising:
a) sealable chamber,
b) rotatable shaft descending downward from the upper portion of said chamber,
c) stirring blade disposed at the end of said shaft distal from the upper portion of said chamber that substantially conforms to the curvature of at least the bottom of said chamber,
d) upper ferro-fluidic seal connecting the upper end of said rotatable shaft to a drive shaft external to said chamber,
e) a lower dual lip seal disposed between the upper fluidic seal and the interior of said chamber that surrounds said rotatable shaft,
f) a first portal in fluid communication with a first region surrounding said rotatable shaft disposed between the upper ferro-fluidic seal and lower lip seal for the selective evacuation and blanketing of said first region,
g) a second portal in fluid communication with a second region surrounding said rotatable shaft disposed between dual lip seals for the selective evacuation and blanketing of said second region.

5. An process for providing pure silicon tetrafluoride (SiF4), the process comprising the steps of:
a) introducing sodium fluorosilicate (SFS) in a reaction chamber, b) providing a first dry vacuum pump having a seal region to evacuate the reaction chamber to less than about 100 torr,
b) providing a compressor to receive the output of the vacuum pump, 10 d) energizing the compressor,
c) providing SiF4 gas to the seal region of the dry vacuum pump,
d) heating the SFS to at least 700° C.,
e) energizing the dry vacuum pump to evacuate the chamber to less than 200 torr,
f) compressing the pure SiF4 formed in the reaction chamber to at least 300 psi.

6. A process for obtaining a pure corrosive gas, the process comprising the steps of:
a) providing a first reaction chamber having at least one outlet port,
b) providing a first dry vacuum pump in fluid communication with the at least one outlet port to evacuate a corrosive gas from the reaction chamber,
c) providing a compressor to receive the output of the vacuum pump,
d) energizing the compressor,
e) providing a pure form of the corrosive gas to the seals of the dry vacuum pump,
f) initiating a reaction that produces the corrosive gas in the reaction chamber,
g) energizing the dry vacuum pump to evacuate the chamber to remove the corrosive gas there from,
h) compressing the corrosive gas that is received from the dry vacuum pump.

7. A process for obtaining a pure corrosive gas according to claim 2 further comprising the steps of filling one or more tanks with the pure compressed gas.

8. A process for obtaining a pure corrosive gas according to claim 2 wherein the pure 15 form of the corrosive gas provided to the seals of the dry vacuum pump is obtained from a tank of the pure compressed gas.

9. A process for obtaining a pure corrosive gas according to claim 2 wherein the pure form of the corrosive gas provided to the seals of the dry vacuum pump is obtained from by bleeding the pure gas from a line connecting the output of the dry pump to the compressor.

10. A process for obtaining a pure corrosive gas according to claim 2 further comprising the step of introducing sodium fluorosilicate (SFS) to the reaction chamber and said step of initiating a reaction that produces the corrosive gas in the reaction chamber comprises heating the SFS to at least about 700° C. to produce SiF4 as the pure corrosive gas.

11. A process for obtaining a pure corrosive gas according to claim 6 wherein said step of energizing the dry vacuum pump to evacuate the chamber to remove the SiF4 comprises evacuating the reaction chamber to less than about 100 torr.

12. A process for obtaining a pure corrosive gas according to claim 7 wherein said step of compressing the corrosive gas that is received from the dry vacuum pump comprises compressing the pure SiF4 formed in the reaction chamber to at least about 300 psi.

13. A process for obtaining a pure corrosive gas according to claim 7 wherein the pure SiF4 formed in the reaction chamber is compressed in multiple stages.

14. A process for obtaining a pure corrosive gas according to claim 1 wherein portions of the pump exposed to the SiF4 vapor are constructed of materials that are substantially non-reactive therewith.

15. A process for obtaining a pure corrosive gas according to claim 6 wherein portions of the pump exposed to the SiF4 vapor are constructed of materials that are substantially non-reactive therewith.

16. A process for obtaining a pure corrosive gas according to claim 10 wherein portions of the pump exposed to the SiF4 vapor are constructed of materials selected from the group consisting of pure nickel and flouropolymers.

17. A process for obtaining a pure corrosive gas according to claim 11 wherein portions of the pump exposed to the SiF4 vapor are constructed of materials selected from the group consisting of pure nickel and flouropolymers.
